(19) United States
(12) Patent Application Publication
(10) Pub. No.: US 2011/0019668 A1
(43) Pub. Date: Jan. 27, 2011

(54) Method And System For Packet Preemption Via Packet Rescheduling

(76) Inventors: Wael William Diab, San Francisco, CA (US); Michael Johas Teener, Santa Cruz, CA (US); Bruce Currivan, Dove Canyon, CA (US); Jeyhan Karaoguz, Irvine, CA (US); Yong Kim, San Jose, CA (US); Kenneth Ma, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 12/571,147

(22) Filed: Sep. 30, 2009

Related U.S. Application Data
(60) Provisional application No. 61/228,339, filed on Jul. 24, 2009.

(51) Int. Cl. H04L 12/56

(52) U.S. Cl. 370/389

(57) ABSTRACT

Link partners coupled via an Ethernet link comprise memory buffers and/or PHY devices and the memory buffers may be operable to buffer packets that are pending delivery via the PHY devices. Latency requirements may be determined by inspecting OSI layer 2 or higher OSI layer information. Markings within packets may be inspected for latency requirements. An order of communicating buffered packets may be determined based on latency requirements. Corresponding packet headers may be ordered based on the latency requirements. Packet delivery may be scheduled based on the latency requirements. A specified time and/or a specified quantity of buffered data, which may be statically or dynamically programmable and/or configurable, may trigger determination of latency requirements. Packets may be delivered after an indication that prior packets have been delivered. Latency requirements may depend on a device that may generate and/or render the packets.

### CROSS-REFERENCE TO RELATED APPLICATIONS/INCORPORATION BY REFERENCE

This application makes reference to, claims priority to, and claims the benefit of U.S. Provisional Application Ser. No. 61/228,339, filed on Jul. 24, 2009.

This patent application makes reference to:

U.S. patent application Ser. No. ______ (Attorney Docket No. 20379US01), which was filed on ______; and

U.S. patent application Ser. No. ______ (Attorney Docket No. 20384US01), was filed on ______.

Each of the above stated applications is hereby incorporated herein by reference in its entirety.

### FIELD OF THE INVENTION

Certain embodiments of the invention relate to networking. More specifically, certain embodiments of the invention relate to a method and system for packet preemption via packet rescheduling.

### BACKGROUND OF THE INVENTION

Communications networks and in particular Ethernet networks, are becoming an increasingly popular means of exchanging data of various types and sizes for a variety of applications. In this regard, Ethernet networks are increasingly being utilized to carry voice, data, and multimedia traffic. Accordingly more and more devices are being equipped to interface to Ethernet networks. Broadband connectivity including internet, cable, phone and VOIP offered by service providers has led to increased traffic and more recently, migration to Ethernet networking. Much of the demand for Ethernet connectivity is driven by a shift to electronic lifestyles involving desktop computers, laptop computers, and various handheld devices such as smart phones and PDA's. Applications such as search engines, reservation systems and video on demand that may be offered at all hours of a day and seven days a week, have become increasingly popular.

These recent developments have led to increased demand on datacenters, aggregation, high performance computing (HPC) and core networking. As the number of devices connected to data networks increases and higher data rates are required, there is a growing need for new transmission technologies which enable higher data rates.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for packet preemption via packet rescheduling, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary Ethernet connection between two network devices, in accordance with an embodiment of the invention.

FIG. 2A is a block diagram illustrating an exemplary packet comprising an OSI L2 mark, in accordance with an embodiment of the invention.

FIG. 2B is a block diagram illustrating an exemplary packet comprising an OSI Ethertype mark, in accordance with an embodiment of the invention.

FIG. 2C is a block diagram illustrating an exemplary packet comprising an IP mark, in accordance with an embodiment of the invention.

FIG. 3 is a block diagram illustrating an exemplary network device that is operable to sort packet information according to latency requirements of packet data, in accordance with an embodiment of the invention.

FIG. 4A is a block diagram illustrating an exemplary egress queue prior to sorting packets and/or packet headers according to latency requirements, in accordance with an embodiment of the invention.

FIG. 4B is a block diagram illustrating an exemplary egress queue after sorting packets and/or packet headers according to latency requirements, in accordance with an embodiment of the invention.

FIG. 5 is a flow chart illustrating exemplary steps for transmitting packet data according to various latency requirements of packet data, in accordance with an embodiment of the invention.

### DETAILED DESCRIPTION OF THE INVENTION

Certain embodiments of the invention can be found in a method and system for packet preemption via packet rescheduling. In various embodiments of the invention, an Ethernet network may comprise one or more link partners that may be coupled via an Ethernet link. The one or more link partners may comprise one or more memory buffers and/or one or more PHY devices. The one or more memory buffers may be operable to buffer packets that may be pending delivery via the one or more PHY devices. Latency requirements may be determined for the one or more of buffered packets. The buffered packets may be communicated to the link partner. In this regard, the order of packets being delivered to the link partner may be determined based on the determined latency requirements.

The latency requirements of the packets pending delivery may be determined by inspecting OSI layer 2 or higher OSI layer information within the buffered packets. For example, one or more markings within the buffered packets may be inspected to determine the latency requirements. Markings within a packet may be referred to as a tag, a mark and/or embedded bits. The buffered packets that are pending delivery may be ordered according to the determined latency requirements. Moreover, packet headers corresponding to the buffered packets pending delivery may be ordered based on the determined latency requirements. The buffered packets may be scheduled for delivery based on the determined latency requirements. The latency requirements may be determined within a specified time and/or for a specified quantity of data that may correspond to the buffered packets pending delivery. In this regard, the specified time and/or the specified quantity of data may be programmable and/or configurable. The one or more link partners may wait for an indication that may specify an end of a delivery of other prior packets before communicating the buffered packets that are pending delivery to another link partner. In various embodiments of the invention, the latency requirements may depend on an application and/or a capability of a device that may generate and/or render the packets that are pending delivery.

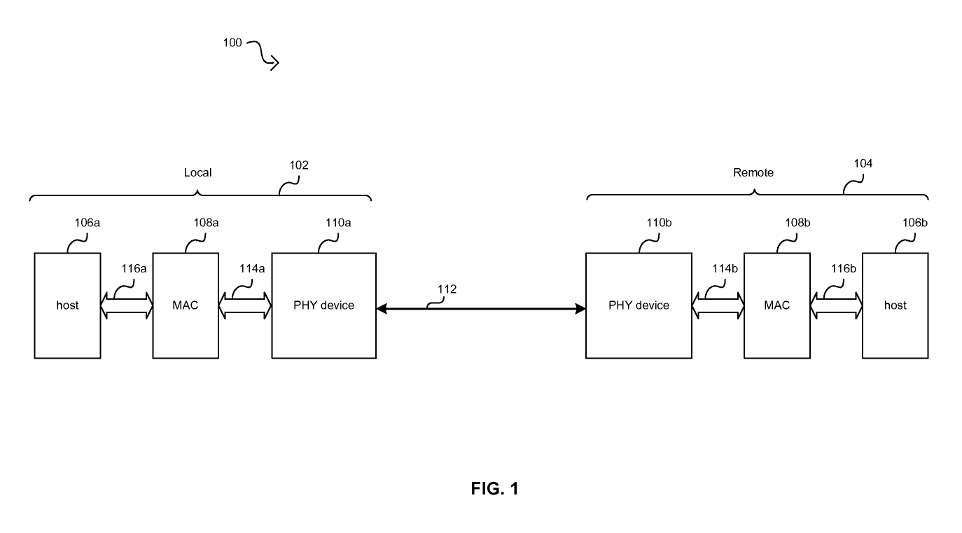

FIG. 1 is a block diagram illustrating an exemplary Ethernet connection between two network devices, in accordance with an embodiment of the invention. Referring to FIG. 1, there is shown a system 100 that comprises a network device 102 and a network device 104. In addition, there is shown two hosts 106a and 106b, two medium access (MAC) controllers 108a and 108b, a PHY device 110a and a PHY device 110b, interfaces 114a and 114b, bus controller interfaces 116a and 116b and a link 112

The network devices 102 and 104 may be link partners that may communicate via the link 112. The Ethernet link 112 is not limited to any specific medium and may utilize any suitable medium. Exemplary Ethernet link 112 media may comprise copper, optical and/or backplane technologies. For example, a copper medium such as STP, Cat3, Cat 5, Cat 5e, Cat 6, Cat 7 and/or Cat 7a as well as ISO nomenclature variants may be utilized. Additionally, copper media technologies such as InfiniBand, Ribbon and backplane may be utilized. With regard to optical media for the Ethernet link 112, single mode fiber as well as multi-mode fiber may be utilized. In various embodiments of the invention, one or both of the network devices 102 and 104 may be operable to comply with one or more standards based on IEEE 802.3, for example, 802.3az.

In an exemplary embodiment of the invention, the link 112 may comprise up to four or more physical channels, each of which may, for example, comprise an unshielded twisted pair (UTP). The network device 102 and the network device 104 may communicate via two or more physical channels comprising the link 112. For example, Ethernet over twisted pair standards 10BASE-T and 100BASE-TX may utilize two pairs of UTP while Ethernet over twisted pair standards 1000BASE-T and 10 GBASE-T may utilize four pairs of UTP. In this regard, however, aspects of the invention may enable varying the number of physical channels via which data is communicated.

The network device 102 may comprise a host 106a, a medium access control (MAC) controller 108a and a PHY device 110a. The network device 104 may comprise a host 106b, a MAC controller 108b, and a PHY device 110b. The PHY device(s) 110a and/or 110b may be pluggable transceiver modules or may be an integrated PHY device. Notwithstanding, the invention is not limited in this regard. In various embodiments of the invention, the network device 102 and/or 104 may comprise, for example, a network switch, a router, computer systems or audio/video (A/V) enabled equipment. In this regard, A/V equipment may, for example, comprise a microphone, an instrument, a sound board, a sound card, a video camera, a media player, a graphics card, or other audio and/or video device. The network devices 102 and 104 may be enabled to utilize Audio/Video Bridging and/or Audio/video bridging extensions (collectively referred to herein as audio video bridging or AVB) for the exchange of multimedia content and associated control and/or auxiliary data.

In various embodiments of the invention, one or both of the network devices 102 and 104 may be configured as an endpoint device and/or one or both of the network devices 102 and 104 may be configured as an internal network core device. Moreover, one or both of the network devices 102 and 104 may be operable to determine latency requirements of packet data that may be pending delivery and may transmit the packet data to a link partner in an order based on the latency requirements. In various exemplary embodiments of the invention, the network device 102 and/or 104 may be operable to insert into packet data, information that may indicate latency requirements of the packet data. In this regard, one or both of the network devices 102 and 104 may be configured as a network node along a communication path of the packet data comprising latency information. One or both of the network devices 102 and 104 may be operable to inspect the inserted latency information and may determine the order for transmitting the one or more packets based on the inserted latency information. In other exemplary embodiments of the invention, one or both of the network devices 102 and 104 may be configured to perform packet inspection, wherein OSI layer 2 and/or higher layer packet headers and/or packet data may be inspected to determine which type of data and/or latency requirements that the packet may comprise.

The PHY device 110a and the PHY device 110b may each comprise suitable logic, circuitry, interfaces and/or code that may enable communication, for example, transmission and reception of data, between the network device 102 and the network device 104. The PHY device(s) 110a and/or 110b may comprise suitable logic, circuitry, interfaces and/or code that may provide an interface between the network device(s) 102 and/or 104 to an optical and/or copper cable link 112.

The PHY device 110a and/or the PHY device 110b may be operable to support, for example, Ethernet over copper, Ethernet over fiber, and/or backplane Ethernet operations. The PHY device 110a and/or the PHY device 110b may enable multi-rate communications, such as 10 Mbps, 100 Mbps, 1000 Mbps (or 1 Gbps), 2.5 Gbps, 4 Gbps, 10 Gbps, 40 Gbps or 100 Gbps for example. In this regard, the PHY device 110a and/or the PHY device 110b may support standard-based data rate limits and/or non-standard data rate limits. Moreover, the PHY device 110a and/or the PHY device 110b may support standard Ethernet link lengths or ranges of operation and/or extended ranges of operation. The PHY device 110a and/or the PHY device 110b may enable communication between the network device 102 and the network device 104 by utilizing a link discovery signaling (LDS) operation that enables detection of active operations in the other network device. In this regard the LDS operation may be configured to support a standard Ethernet operation and/or an extended range Ethernet operation. The PHY device 110a and/or the PHY device 110b may also support autonegotiation for identifying and selecting communication parameters such as speed and duplex mode.

The PHY device 110a and/or the PHY device 110b 10b may comprise a twisted pair PHY capable of operating at one or more standard rates such as 10 Mbps, 100 Mbps, 1 Gbps, and 10 Gbps (10BASE-T, 100 GBASE-TX, 1 GBASE-T, and/or 10 GBASE-T); potentially standardized rates such as 40 Gbps and 100 Gbps; and/or non-standard rates such as 2.5 Gbps and 5 Gbps. The PHY device 110a and/or the PHY device 110b may comprise a backplane PHY capable of operating at one or more standard rates such as 10 Gbps (10 GBASE-KX4 and/or 10 GBASE-KR); and/or non-standard rates such as 2.5 Gbps and 5 Gbps. The PHY device 110a and/or the PHY device 110b may comprise a optical PHY capable of operating at one or more standard rates such as 10 Mbps, 100 Mbps, 1 Gbps, and 10 Gbps; potentially standardized rates such as 40 Gbps and 100 Gbps; and/or non-standardized rates such as 2.5 Gbps and 5 Gbps. In this regard, the optical PHY may be a passive optical network (PON) PHY.

The PHY device 110a and/or the PHY device 110b may support multi-lane topologies such as 40 Gbps CR4, ER4, KR4; 100 Gbps CR10, SR10 and/or 10 Gbps LX4 and CX4. Also, serial electrical and copper single channel technologies such as KX, KR, SR, LR, LRM, SX, LX, CX, BX10, LX10 may be supported. Non standard speeds and non-standard technologies, for example, single channel, two channel or four channels may also be supported. More over, TDM technologies such as PON at various speeds may be supported by the network devices 102 and/or 104.

In various embodiments of the invention, the PHY device 110a and/or the PHY device 110b may comprise suitable logic, circuitry, and/or code that may enable transmission and/or reception at a high(er) data in one direction and transmission and/or reception at a low(er) data rate in the other direction. For example, the network device 102 may comprise a multimedia server and the network device 104 may comprise a multimedia client. In this regard, the network device 102 may transmit multimedia data, for example, to the network device 104 at high(er) data rates while the network device 104 may transmit control or auxiliary data associated with the multimedia content at low(er) data rates.

The data transmitted and/or received by the PHY device 110a and/or the PHY device 110b may be formatted in accordance with the well-known OSI protocol standard. The OSI model partitions operability and functionality into seven distinct and hierarchical layers. Generally, each layer in the OSI model is structured so that it may provide a service to the immediately higher interfacing layer. For example, layer 1, or physical layer, may provide services to layer 2 and layer 2 may provide services to layer 3. The hosts 106a and 106b may implement layer 3 and above, the MAC controllers 108a and 108b may implement layer 2 and above and the PHY device 110a and/or the PHY device 110b may implement the operability and/or functionality of layer 1 or the physical layer. In this regard, the PHY device 110a and/or the PHY device 110b may be referred to as physical layer transmitters and/or receivers, physical layer transceivers, PHY transceivers, PHYceivers, or PHY, for example. The hosts 106a and 106b may comprise suitable logic, circuitry, and/or code that may enable operability and/or functionality of the five highest functional layers for data packets that are to be transmitted over the link 112. Since each layer in the OSI model provides a service to the immediately higher interfacing layer, the MAC controllers 108a and 108b may provide the necessary services to the hosts 106a and 106b to ensure that packets are suitably formatted and communicated to the PHY device 110a and/or the PHY device 110b. During transmission, a device implementing a layer function may add its own header to the data passed on from the interfacing layer above it. However, during reception, a compatible device having a similar OSI stack may strip off the headers as the message passes from the lower layers up to the higher layers.

The PHY device 110a and/or the PHY device 110b may be configured to handle physical layer requirements, which include, but are not limited to, packetization, data transfer and serialization/deserialization (SERDES), in instances where such an operation is required. Data packets received by the PHY device 110a and/or the PHY device 110b from MAC controllers 108a and 108b, respectively, may include data and header information for each of the six functional layers above the PHY layer. The PHY device 110a and/or the PHY device 110b may be configured to encode data packets that are to be transmitted over the link 112 and/or to decode data packets received from the link 112.

In various embodiments of the invention, one or both of the PHY device 110a and the PHY device 110b, may comprise suitable logic, circuitry, interfaces, and/or code that may be operable to implement one or more energy efficient Ethernet (EEE) techniques in accordance with IEEE 802.3az as well as other energy efficient network techniques. For example, the PHY device 110a and/or the PHY device 110b may be operable to support low power idle (LPI) and/or sub-rating, also referred to as subset PHY, techniques. LPI may generally refer a family of techniques where, instead of transmitting conventional IDLE symbols during periods of inactivity, the PHY device 110a and/or the PHY device 110b may remain silent and/or communicate signals other than conventional IDLE symbols. Sub-rating, or sub-set PHY, may generally refer to a family of techniques where the PHYs are reconfigurable, in real-time or near real-time, to communicate at different data rates.

In various embodiments of the invention, the hosts 106a and/or 106b may be operable to communicate control information with the PHY devices 110a and/or 110b via an alternate path. For example, the host 106a and/or the host 106b may be operable to communicate via a general purpose input output (GPIO) and/or a peripheral component interconnect express (PCI-E).

The MAC controller 108a may comprise suitable logic, circuitry, and/or code that may enable handling of data link layer, layer 2, operability and/or functionality in the network device 102. Similarly, the MAC controller 108b may comprise suitable logic, circuitry, and/or code that may enable handling of layer 2 operability and/or functionality in the network device 104. The MAC controllers 108a and 108b may be configured to implement Ethernet protocols, such as those based on the IEEE 802.3 standards, for example. Notwithstanding, the invention is not limited in this regard.

The MAC controller 108a may communicate with the PHY device 110a via an interface 114a and with the host 106a via a bus controller interface 116a. The MAC controller 108b may communicate with the PHY device 110b via an interface 114b and with the host 106b via a bus controller interface 116b. The interfaces 114a and 114b correspond to Ethernet interfaces that comprise protocol and/or link management control signals. For example, the interface 114 may comprise a control interface such as a management data input/output (MDIO) interface. Furthermore, the interfaces 114a and 114b may comprise multi-rate capable interfaces and/or media independent interfaces (MII). For example, the interfaces 114a and/or 114b may comprise a media independent interface such as a XGMII, a GMII, or a RGMII for communicating data to and/or from the PHY device 110a. In this regard, the interface 114 may comprise a signal to indicate that data from the MAC controller 108a to the PHY device 110a is imminent on the interface 114a. Such a signal is referred to herein as a transmit enable (TX_EN) signal. Similarly, the interface 114a may utilize a signal to indicate that data from the PHY 110a to the MAC controller 108a is imminent on the interface 114a. Such a signal is referred to herein as a receive data valid (RX_DV) signal. The interfaces 114a and/or 114b may be configured to utilize a plurality of serial data lanes for sending and/or receiving data. The bus controller interfaces 116a and 116b may correspond to PCI or PCI-X interfaces. Notwithstanding, the invention is not limited in this regard.

In operation, one or both network devices 102 and 104 may be operable to determine latency requirements of one or more packets pending delivery and may transmit the one or more packets in an order specified according to the latency requirements. For example, one or more of the packets may comprise one or more markings that may indicate latency requirements and/or a latency class assigned to a packet. The marking or tag information may indicate that one or more packets may have higher priority over other packets that may be pending delivery. For example, the marking may provide an indication that a packet may be assigned a premium service class and/or may require a level of latency that is appropriate for successful communication of a particular type of data, for example, voice over IP data, multi-party interactive Internet gaming data and/or web browsing data. The markings or tags may be standardized and/or non-standardized, for example. In various embodiments of the invention, the marks may be tags, for example, that may be utilized based on an IEEE 802.1 standard and/or an extension and/or variation thereof. For example, reserved bits may be utilized for marking a packet.

In an exemplary embodiment of the invention, the host device 106a may comprise a switch that may determine latency requirements for one or more data packets pending delivery from the PHY device 110a to the link partner 104. The host device 106a may communicate the packet data to the MAC controller 108a in an order that may be determined based on sensitivity of the data to latency and/or latency constraints. In this regard, the packet data may be ordered from data with a greater requirement for low latency to data that may be less sensitive to latency. For example, the data pending delivery may comprise one or more of interactive online gaming data, voice over IP (VOIP) data, email data and web browsing data. The interactive online gaming data and/or VOIP data may require a lower latency relative to other types of data that are pending delivery. The network device 102 may communicate the interactive online gaming data and/or prior to the other types of packet data. In this manner, exemplary embodiments of the invention may be compatible with legacy MAC controllers and/or legacy PHY devices.

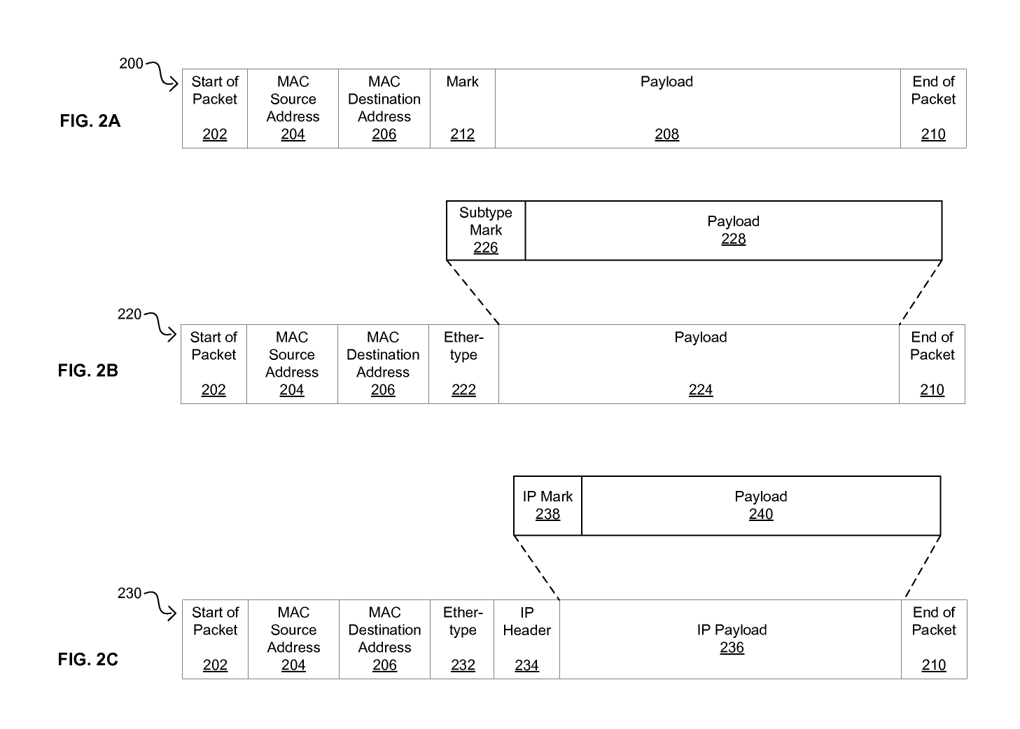

FIG. 2A is a block diagram illustrating an exemplary packet comprising an OSI L2 mark, in accordance with an embodiment of the invention. Referring to FIG. 2A, there is shown a data packet 200 that may comprise a start of a packet header 202, a MAC source address header (MAC SAH) 204, a MAC destination address header (MAC DAH) 206, a payload 208, and an end of packet header 210 and a mark 212.

The start of packet header 202 may comprise data that may indicate to a receiving communication device, for example the network device 104, where the packet 200 begins. The MAC SAH 204 may comprise data that may indicate which communication device is transmitting the packet 200 and the MAC DAH 206 may indicate which device is receiving the packet 200. The payload 208 may comprise packet data and/or headers for OSI higher layer processing. The payload 208 may comprise data transmitted from an endpoint device that may be stored in the endpoint device and/or generated by an application in the endpoint device. For example, the payload 208 may comprise video conferencing data, multi-party Internet gaming data, VOIP data and/or web browsing data, for example. Accordingly, the payload 208 may require a specified level of latency in order to realize an acceptable quality of communication. Moreover, the payload 208 may require a specified class of service based on a service or subscriber agreement purchased by a user associated with the payload 208. The end of packet 210 may indicate to a receiving device, for example, the network device 104 where the packet 200 ends. The mark 212 may comprise bits embedded within the packet 200 and/or may be part of an OSI layer 2 and/or higher OSI layer header. For example, an endpoint device, application software on the endpoint device and/or a network node may be operable to originate communication of the payload 208 and/or may generate a mark in an OSI layer 2 or higher OSI layer header. In another exemplary embodiment of the invention, a service provider that may manage and/or operate the network devices 102, 104, and/or 230, for example, may insert a mark into a packet.

The packet 200 may comprise one or more marks and/or embedded bits that may indicate criteria for processing and/or routing the packet 200 via one or more network nodes, for example, via the network devices 102, 104, and/or 330. In various embodiments of the invention, the one or more marks, tags and/or embedded bits within the packet 200 may correspond to various routing parameters, network node capabilities and/or costs associated with a specified communication device and/or network node. In this regard, the mark, tag and/or embedded bits may indicate how the packet 200 may be processed, prioritized and/or routed.

FIG. 2B is a block diagram illustrating an exemplary packet comprising an OSI Ethertype mark, in accordance with an embodiment of the invention. Referring to FIG. 2B, there is shown a data packet 220 that may comprise the start of a packet header 202, the MAC source address header (MAC SAH) 204, the MAC destination address header (MAC DAH) 206, and the end of packet header 210. In addition, there is shown an Ethertype 222, a payload 224, a subtype mark 226 and a payload 228.

The Ethertype 222 field may comprise information that may be utilized to identify the protocol being transported in the packet, for example, IPv4 or IPv6. The protocol indicated by the Ethertype may utilize marks within the data packet 220 that may specify a type of traffic that the packet 200 belongs to. The type of traffic may indicate how the packet 200 may be processed, prioritized and/or routed. In this regard, a network device may look for the marks within the payload 234 when the Ethertype 222 field indicates a protocol that utilizes the marks. In an exemplary embodiment of the invention, the network device may be operable to parse the payload 228 to find the subtype mark 226 that may comprise the traffic type information.

FIG. 2C is a block diagram illustrating an exemplary packet comprising an IP mark, in accordance with an embodiment of the invention. Referring to FIG. 2C, there is shown a data packet 230 that may comprise the start of a packet header 202, the MAC source address header (MAC SAH) 204, the MAC destination address header (MAC DAH) 206 and the end of packet header 210. In addition, there is shown an Ethertype 232 an IP header 234, a payload 236, an IP mark 238 and a payload 240.

The Ethertype 232 field may comprise information that may be utilized to identify the protocol being transported in the packet, for example, IPv4 or IPv6. The IP header 234 may comprise information about the packet such as an ID and/or version for the packet, source and destination information and/or protocol information. In various embodiments of the invention, the IP header 234 may comprise a mark to indicate the type of traffic or content comprised within the packet that may determine how the packet 200 may be processed, prioritized and/or routed. In other embodiments of the invention, the mark may be embedded in the IP payload 236. For example, a network device that may receive the packet 230 may parse the IP payload 236 to find the IP Mark 238 that may comprise the traffic type information.

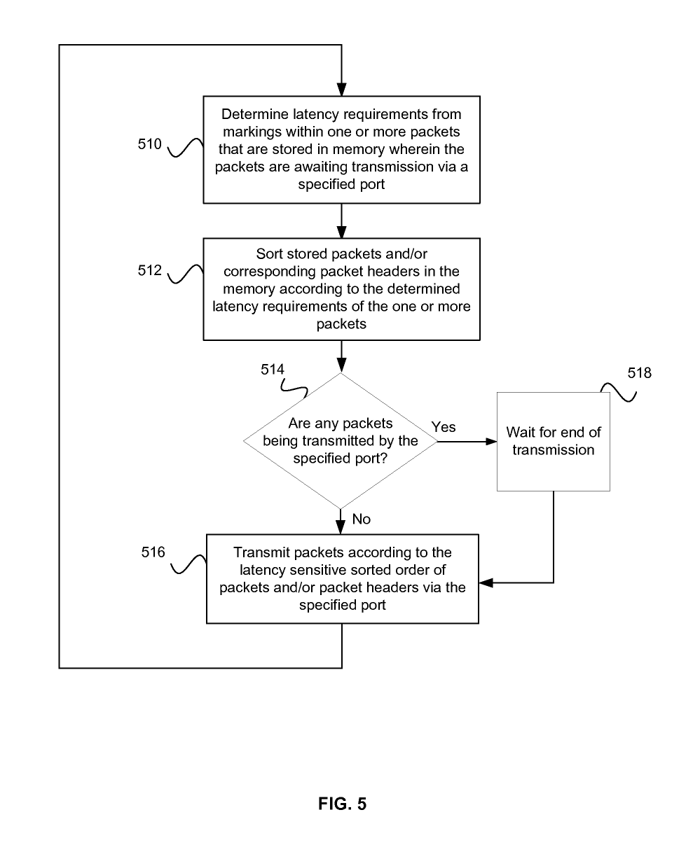

In operation, one or more packets, for example, the one or more of the packets 200, 220 and 230 may be generated by an endpoint device (described with respect to FIG. 5). The endpoint device may have a certain capability and/or may host an application that may generate one or more of the packets 200, 220 and 230. For example, the packets 200, 220 and/or 230 may comprise multi-party interactive Internet gaming data that may require a very low latency in order for the interactive game to adequately communicate high speed input by a plurality of users. The endpoint device may generate one or more of the marks 212, 226 and/or 238 that may indicate the endpoint device multi-party interactive Internet gaming capability. In this regard, a network node, for example, the communication device 201a may receive one or more of the packets 200, 220 and 230 and may parse the packet and/or may perform packet inspection in order to determine the endpoint device capabilities. For example, the communication device 201a may inspect the mark 212, 226 and/or 238 and may determine that the packet 200, 220 and/or 230 comprises multi-party interactive Internet gaming capability and/or requires very low latency communication. Accordingly, the communication device 201a may determine a path for routing the packet 200, 220 and/or 230 based on one or more routing parameters stored within the device. For example, the communication device 201a may route packets based on shortest path bridging and/or may utilize AVB. Furthermore, the communication device 201a may perform real time compression on the one or more packets 200, 220 and 230 data that may reduce the packet size by a factor of two, for example. The network device 102 may also preempt one or more other packets that may be pending delivery by the network device 102 so that the multi-party interactive Internet gaming data from the packets 200, 220 and/or 230 may be communicated to the network device 104, for example, with very low latency.

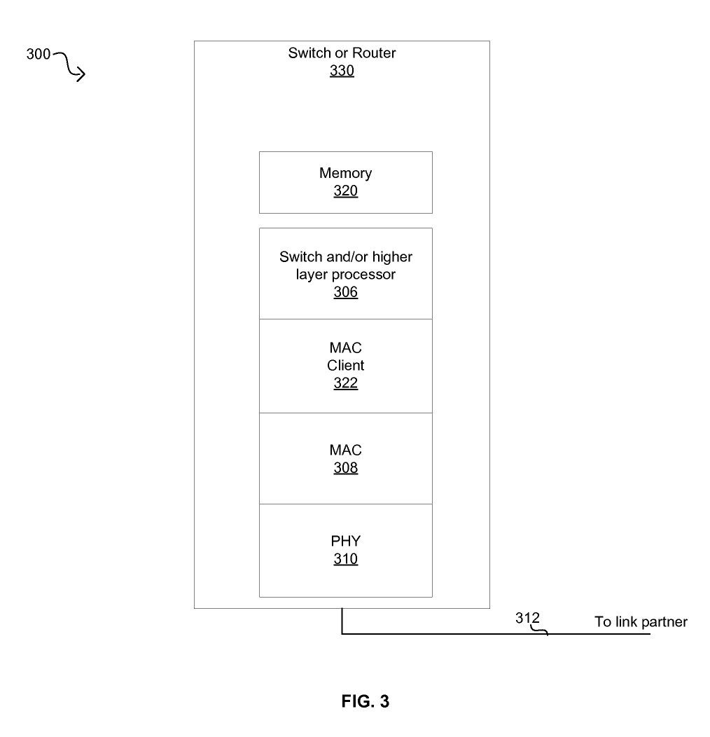

FIG. 3 is a block diagram illustrating an exemplary network device that is operable to sort packet information according to latency requirements of packet data, in accordance with an embodiment of the invention. Referring to FIG. 3, there is shown a system 300 comprising a network device 330 and a communication link 312. The network device 330 may comprise a switch and/or higher layer processor 306, a MAC client 322, a MAC controller 308, a PHY device 310 and a memory 320.

The network device 330 may be similar or substantially the same as the network devices 102 and/or 104 described with respect to FIG. 1. The communication link 312 may be similar and/or substantially the same as the link 112. The switch and/or higher layer processor 306, the MAC controller 308 and the PHY device 310 may be similar and/or substantially the same as the hosts 106a and/or 106b, the MAC 108a and 108b and/or the PHY devices 110a and/or 110b respectively.

The MAC client block 304 may comprise suitable logic, circuitry, interfaces and/or code that may be operable to receive packet data from the switch and/or higher layer processor 306 and/or to encapsulate the packet data as Ethernet payloads into one or more Ethernet frames. The Ethernet frames may be communicated from the MAC client block 304 to the MAC controller 308.

The memory 320 may comprise suitable logic, circuitry, interfaces and/or code that may be operable to store packet data and/or packet information, for example, packet headers. In this regard, the memory 320 may comprise and egress queue for the network device network device 330. The memory 320 may comprise an index and/or linked list, for example, of packet headers, which may comprise pointers that correspond to packet data and/or packet information stored in the memory 320. Moreover, the memory 320 may comprise content addressable memory (CAM) that may enable modification of stored information base on a type of content within the memory. For example, control data and/or packet header information that may correspond to stored packet data, may be stored in CAM.

In operation, the network device 330 may be operable to transmit packet data in an order that may be determined based on latency requirements of the packet data. In this regard, the network device 330 may determine latency requirements of one or more packets of data that may be pending transmission from the network device 330. The packet data and/or packet information may be stored in an egress buffer in memory 320. The switch and/or higher layer processors 306 may determine latency requirements and/or service class based on inspection of one or more packets. For example, markings that may indicate latency requirements and/or service class may be inserted in the packet and may be read by the switch and/or higher layer processors 306. For example, latency requirements may depend on an application that generated the packet and/or on a capability of a device that generated and/or may render the packet. Alternatively, layer 2 or higher layer packet headers may be inspected to provide an indication of latency requirements, for example, based on a type of data within the packet. Based on the determined latency requirements, the switch and/or higher layer processor 306 may re-order packet information and/or reschedule packet transmission. The re-ordered packets may be sent to the MAC client 322 and may be processed by the MAC client 322, the MAC 308 and the PHY 310 and may be transmitted via the link 112 in the determined order. In this manner, a packet requiring the lowest latency may be transmitted as soon as possible. In instances when the network device may be in the process of transmitting a prior packet via the link 312 and the packet with the lowest latency may be ready to transmit, the network device 330 may wait for the transmission of the prior packet to end before communicating the lowest latency packet.

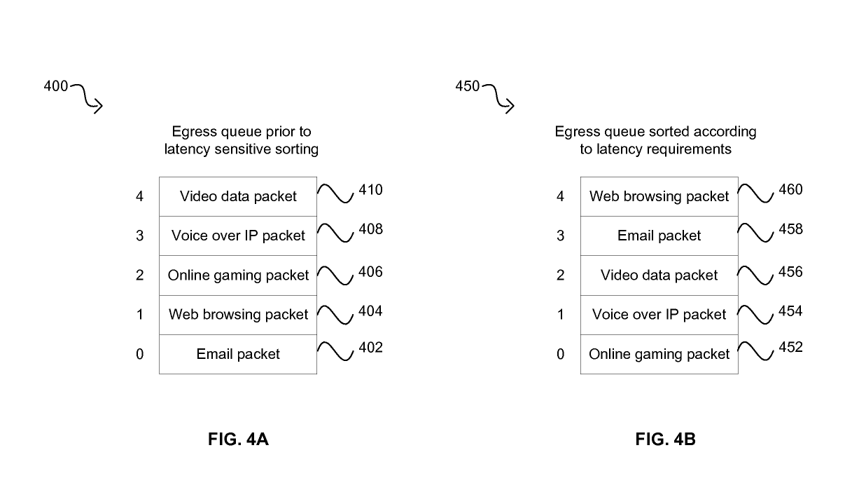

FIG. 4A is a block diagram illustrating an exemplary egress queue prior to sorting packets and/or packet headers according to latency requirements, in accordance with an embodiment of the invention. Referring to FIG. 4A, there is shown an egress queue 400 that may comprise a plurality of storage locations 402, 404, 406, 408 and/or 410.

The egress queue 400 may comprise a portion of the memory 320 described with respect to FIG. 3. In operation, the network device 330 may be operable to store packets and/or packet information, for example, packet headers in the egress queue 400. Packets and/or packet information may be stored and/or indexed within the egress queue 400 in an order that may correspond to an order that the network device 330 may utilize for transmitting the packets to a link partner. For example, the packet and/or a packet corresponding to packet information stored in the memory location 402 may be scheduled to be communicated to the link partner first, followed in order by packets corresponding to memory locations 404, 406, 408 and 410. In this regard, the order may be determined based on an order in which the packets are received and/or processed by the network device 330 and/or based on the order in which packets become available for transmission to a link partner. In various embodiments of the invention, the network device 330, for example, the switch and/or higher layer processor 306 may comprise suitable logic, circuitry, interfaces and/or code that may be operable to determine latency requirements of the packets corresponding to the memory locations 402, 404, 406, 408 and 410 and may modify the order of their transmission to the link partner according to their latency requirements, as described with respect to FIG. 3.

FIG. 4B is a block diagram illustrating an exemplary egress queue after sorting packets and/or packet headers according to latency requirements, in accordance with an embodiment of the invention. Referring to FIG. 4B, there is shown an egress queue 450 that may comprise a plurality of storage locations 452, 454, 456, 458 and/or 460.

The egress queue 450 may comprise the same packets and/or packet information that is stored in the egress queue 400, however, the packets and/or packet information within the egress queue 450 may be sorted and/or scheduled for delivery in a different order that may be determined based on latency requirements of the packets. In this regard, the egress queue 450 may be similar or substantially the same as the egress queue 400. In this regard, the egress queue 450 may comprise a portion of the memory 300 described with respect to FIG. 3. The network device 330 may be operable to store packets and/or packet information, for example, packet headers in the egress queue 450. Packets and/or packet information may be stored within and/or may be indexed within the egress queue 450 in an order that may correspond to an order that the network device 330 may utilize for transmitting the packets to a link partner. For example, the packet and/or a packet corresponding to the packet information stored within the memory location 452 may be scheduled to be communicated to the link partner first, followed in order by packets corresponding to memory locations 454, 456, 458 and 460.

In an exemplary usage scenario, the egress queue 400 may comprise a snapshot of packets and/or packet information corresponding to packets that may be pending delivery to a link partner, prior to sorting and/or scheduling packet delivery based on latency requirements of each the. The packet corresponding to memory location 402 shown in FIG. 4A may comprise an email message packet, the packet corresponding to memory location 404 may comprise data that may be utilized for browsing a website, the packet corresponding to memory location 406 may comprise an online gamming packet from a high speed online interactive video game, the packet corresponding to memory location 408 may comprise a voice over IP (VOIP) packet and/or the packet corresponding to memory location 410 may comprise a packet of video data from a stream of video.

The network device 330, for example, the switch and/or higher layer processor 306 may inspect the packets and/or information about the packets that are stored in the egress queue 400 and may re-order and/or re-schedule delivery of the packets based on latency requirements. In this regard, the switch and/or higher layer processor 306 may determine that the order of deliver should be changed to the order shown in egress queue 450 wherein the online gaming packet corresponding to the memory location 452 may be communicated to the link partner first followed by the voice over IP packet corresponding to the memory location 454, the video packet corresponding to the memory location 456, the email packet corresponding to the memory location 458 and the web browsing packet corresponding to memory location 460. The switch and/or higher layer processor 306 may repeatedly determine in which order queued packets may be delivered. For example, packet delivery order may be determined on a periodic or aperiodic basis, may depend on how many packets are queued, may be programmable and/or configurable. In this manner, packet data comprising more stringent latency requirements may be scheduled for delivery prior to other packets. In various embodiments of the invention, other factors may also be utilized in determining delivery order of packets, for example, quality of service (QoS) information may be utilized along with latency requirements that may be indicated by marking within the packets.

FIG. 5 is a flow chart illustrating exemplary steps for transmitting packet data according to various latency requirements of packet data, in accordance with an embodiment of the invention. Referring to FIG. 5, the exemplary steps may begin with step 510. In step 510, latency requirements may be determined based on markings within one or more packets that may be stored in memory 320 wherein the packets may be awaiting transmission via a specified port of the network device 330, for example, via the PHY 310. For example, high speed, interactive, online gaming may require very low latency for successful communication of fast paced interactive game playing. In this regard, stringent latency requirements may be indicated within communicated gaming packets for online gaming. In step 512, according to the determined latency requirements, the delivery order of the stored packets may be determined. For example, the stored packets and/or packet headers corresponding to the stored packets in the memory 320 may be sorted according to the determined latency requirements. In step 514, in instances when the network device 330 may not be in the process of transmitting another packet via the specified port, the exemplary steps may proceed to step 516. In step 516, the packets stored in memory 320 may be transmitted to a link partner via the specified port in an order determined based on how sensitive the packets are to latency. In step 514, in instances when the network device 330 may be in the process of transmitting another packet via the specified port, the exemplary steps may proceed to step 518. In step 518, the network device may wait until transmission of the other packet has ended.

In an embodiment of the invention, an Ethernet network may comprise one or more link partners, for example, the one or more of the network devices 102, 104 and/or 330 that may be coupled via an Ethernet link 112, for example. The one or more link partners may comprise one or more memory buffers 320 and/or one or more PHY devices, for example PHY devices 110 and/or 310. The one or more memory buffers 320 may be operable to buffer packets that may be pending delivery via the one or more PHY devices, for example the PHY device 310. The packets may be buffered at memory locations memory locations 404, 406, 408 and 410, for example. Latency requirements may be determined for the one or more buffered packets. The buffered packets may be communicated to the link partner, for example, the network device 104. In this regard, the order of packets being delivered to the link partner may be determined based on the determined latency requirements.

In accordance with various embodiments of the invention, the latency requirements of the packets pending delivery may be determined by inspecting OSI layer 2 or higher OSI layer information within the buffered packets. For example, one or more marks and/or tags within the buffered packets may be inspected to determine the latency requirements. The buffered packets that are pending delivery may be ordered according to the determined latency requirements. Moreover, packet headers corresponding to the buffered packets pending delivery may be ordered based on the determined latency requirements. The buffered packets may be scheduled for delivery based on the determined latency requirements. The latency requirements may be determined within a specified time and/or for a specified quantity of data that may correspond to the buffered packets pending delivery. In this regard, the specified time and/or the specified quantity of data may be programmable and/or configurable. The one or more link partners may wait for an indication that may specify an end of a delivery of other prior packets before communicating the buffered packets that are pending delivery to another link partner. In various embodiments of the invention, the latency requirements may depend on an application and/or a capability of a device that may generate and/or render the packets that are pending delivery.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for packet preemption via packet rescheduling.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in an Ethernet network comprising link partners that are coupled via an Ethernet link, one or more of said link partners comprising one or more PHY devices and one or more memory buffers that are operable to buffer packets that are pending delivery via said one or more PHY devices:
determining latency requirements of one or more packets buffered in said one or more memory buffers that are pending delivery; and
communicating said buffered packets that are pending delivery to said link partner in an order that is determined utilizing said determined latency requirements.

2. The method according to claim 1, comprising inspecting OSI layer 2 or higher OSI layer information within said buffered packets that are pending delivery to determine said latency requirements.

3. The method according to claim 1, comprising inspecting one or more markings within said buffered packets that are pending delivery to determine said latency requirements.

4. The method according to claim 1, comprising ordering said buffered packets that are pending delivery based on said determined latency requirements.

5. The method according to claim 1, comprising ordering packet headers corresponding to said buffered packets that are pending delivery based on said determined latency requirements.

6. The method according to claim 5, comprising scheduling delivery of said buffered packets that are pending delivery based on said determined latency requirements.

7. The method according to claim 1, wherein said latency requirements may be determined within a specified time and/or for a specified quantity of data corresponding to said buffered packets that are pending delivery.

8. The method according to claim 7, wherein said specified time and/or said specified quantity of data that is pending delivery is statically or dynamically programmable and/or configurable.

9. The method according to claim 1, comprising waiting for an indication that specifies an end of a delivery of other prior packets before communicating said buffered packets that are pending delivery to said link partner.

10. The method according to claim 1, wherein said determined latency requirements depend on an application and/or a capability of a device that generates and/or renders said packets that are pending delivery.

11. A system for communication, the system comprising:
one or more circuits for use in an Ethernet network comprising link partners that are coupled via an Ethernet link, said one or more circuits comprising one or more PHY devices and one or more memory buffers that are operable to buffer packets that are pending delivery via said one or more PHY devices, wherein said one or more circuits are operable to:
determine latency requirements of one or more packets buffered in said one or more memory buffers that are pending delivery; and
communicate said buffered packets that are pending delivery to said link partner in an order that is determined utilizing said determined latency requirements.

12. The system according to claim 11, wherein said one or more circuits are operable to inspect OSI layer 2 or higher OSI layer information within said buffered packets that are pending delivery to determine said latency requirements.

13. The method according to claim 11, wherein said one or more circuits are operable to inspect one or more markings within said buffered packets that are pending delivery to determine said latency requirements.

14. The system according to claim 11, wherein said one or more circuits are operable to order said buffered packets that are pending delivery based on said determined latency requirements.

15. The system according to claim 11, wherein said one or more circuits are operable to order packet headers corresponding to said buffered packets that are pending delivery based on said determined latency requirements.

16. The system according to claim 15, wherein said one or more circuits are operable to schedule delivery of said buffered packets that are pending delivery based on said determined latency requirements.

17. The system according to claim 11, wherein said latency requirements may be determined within a specified time and/or for a specified quantity of data corresponding to said buffered packets that are pending delivery.

18. The system according to claim 17, wherein said specified time and/or said specified quantity of data that is pending delivery is statically or dynamically programmable and/or configurable.

19. The system according to claim 11, wherein said one or more circuits are operable to wait for an indication that specifies an end of a delivery of other prior packets before communicating said buffered packets that are pending delivery to said link partner.

20. The system according to claim 11, wherein said determined latency requirements depend on an application and/or a capability of a device that generates and/or renders said packets that are pending delivery.
